(19) United States
(12) Patent Application Publication
(10) Pub. No.: US 2009/0278373 A1
(43) Pub. Date: Nov. 12, 2009

(54) C-HINGE FOR GOLF CART FOLDING WINDSHIELD

(75) Inventors: James Rouzer, Elgin, IL (US); Chan Wah Su, Elgin, IL (US); Franky Wan, Elgin, IL (US)

Correspondence Address: DENNIS G. LAPOINTE;LAPOINTE LAW GROUP, PL, PO BOX 1294, TARPON SPRINGS, FL, 34688-1294, US

(73) Assignee: CHINAMERICA INDUSTRIES, INC., Largo, FL (US)

(21) Appl. No.: 12/116,280

(22) Filed: May 7, 2008

(51) Int. Cl. B60J 1/02

(52) U.S. Cl. 296/92

(57) ABSTRACT

A windshield hinge system that hinges a foldable golf cart windshield. The upper and lower portions of the windshield are hingedly joined together at an intermediate level with a hinge mechanism that has two opposing spaced-apart C-shaped members joined together by a flexible and foldable intermediate member. The intermediate member serves to hingedly rotate the upper and lower portions of the windshield when desired. The C-shaped members interlockingly engage sides of respective upper and lower portions of the windshield within respective legs of each C-shaped member. The C-shaped members are made of a polyvinyl chloride material while the intermediate member is made from a resilient foldable and flexible polyuoruethane material.

### FIELD OF THE INVENTION

The invention relates to a golf cart folding windshield that is hinged without the use of rivets or glue by using a novel hinge mechanism.

### BACKGROUND OF THE INVENTION

Golf cart folding windshields are typically plastic components hinged across an approximate center to the windshield using glue or rivets to adhere the hinge to the surface of the windshield plastic material. The present invention obviates the necessity for riveting or gluing the hinge portion to the windshield sections.

### SUMMARY OF THE INVENTION

The invention is a windshield hinge system for use with a golf cart folding windshield comprising. Typical golf cart windshields that are foldable have an upper portion and a lower portion, which are being hingedly joined together at an intermediate level with a hinge mechanism. The invention is directed at a new hinge system for incorporation into the folding windshields.

The hinge mechanism comprises two opposing spaced-apart generally C-shaped members joined together by a flexible and foldable intermediate member. The flexible and foldable intermediate member serves to hingedly rotate the upper and lower portions of the windshield when desired. The C-shaped members have means for interlockingly engaging the sides of the respective upper and lower portions of the windshield within respective legs of each C-shaped member.

Each C-shaped member further comprises a ridge extending inwardly from each of the respective legs. The ridges are configured to frictionally engage and interlock with a mating groove on a front and back surface of each respective upper and lower portions of the windshield.

In a preferred embodiment, the ridge is tapered so as to facilitate the sliding engagement of the sides of the respective upper and lower portions of the windshield within the respective legs of each C-shaped member.

Each C-shaped member is typically made from a polyvinyl chloride based material and the flexible and foldable intermediate member is typically made from a resilient and durable polyurethane based material. The C-shaped members are each integrally bonded to respective ends of the flexible and foldable intermediate member. The polyvinyl chloride based material has a durometer of about 90 or greater.

The groove in each front and back surface or sides of the upper and lower portions of the windshield has a preferred width of about 2 mm, a depth of about 0.9 mm and is spaced about 6.5 mm from an edge of the windshield. Each ridge in the C-shaped member is spaced-apart from each other so as to form a gap therebetween of about 2.2 mm. The flexible and foldable intermediate member has a thickness of about 1.5 mm and a length of about 5.4 mm.

### BRIEF DESCRIPTION OF THE DRAWINGS

In the accompanying drawings:

FIG. 1 is a perspective view of the invention installed on a golf cart;

FIG. 2 is a perspective view of the invention installed between upper and lower portions of the windshield assembly;

FIG. 3 is a partial enlarged view of the end of the hinge assembly between the upper and lower portions of the windshield;

FIG. 4 is a partial enlarged view of the end of the hinge assembly between the upper and lower portions of the windshield similar to FIG. 3 except with the upper and lower portions of the windshield being in a folded position; and

FIG. 5 is an exploded view of an end of the hinge assembly with a portion of the lower windshield.

### DETAILED DESCRIPTION OF THE INVENTION

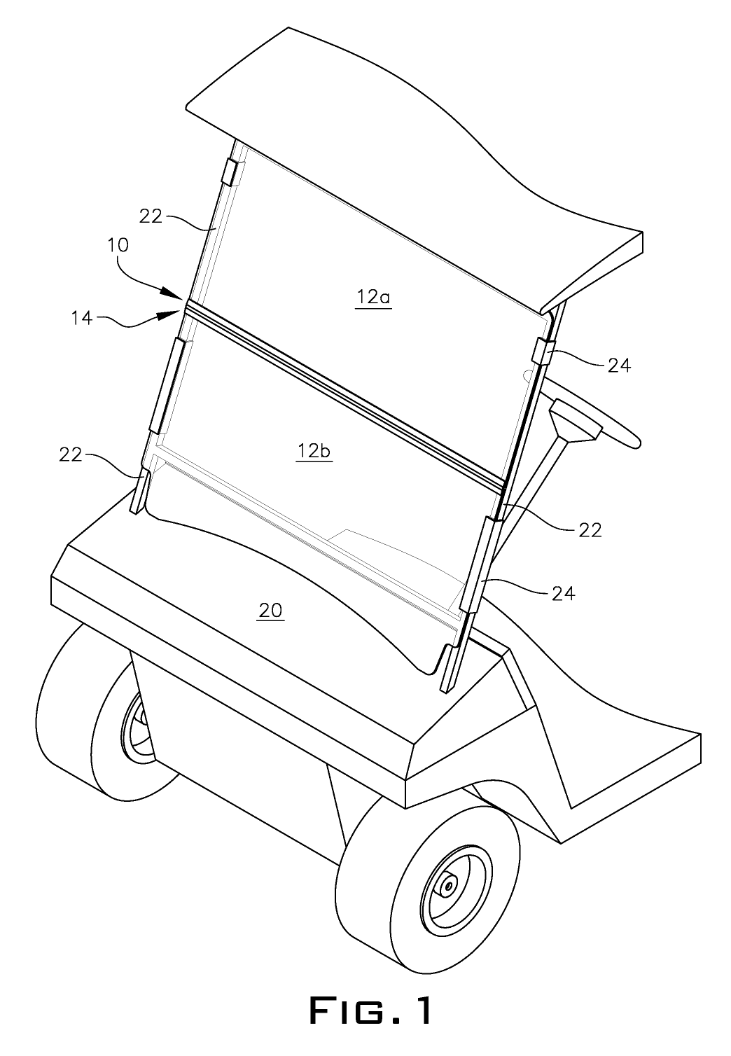

Referring now to the drawings, FIG. 1 discloses the present invention in use on a golf cart 20, which is a windshield hinge system for use with a golf cart and is depicted generally as 10. The system 10 is used with a golf cart windshield 12, which is made up of two components, an upper portion 12a and a lower portion 12b. The upper and lower portions 12a, 12b are hingedly joined together at an intermediate level with a hinge mechanism 14. As shown in FIG. 1, which is representational of typical folding windshields, the lower portion 12b is typically attached to the frame 22 using a rubber clamp type of arrangement or in some cases actually fastened to the frame 22. The hinged upper portion 12a usually rest against the bottom portion 12b when folded and can be lifted and clamped to the frame 20 using a rubber clamp 24 at the sides of the upper portion 12a.

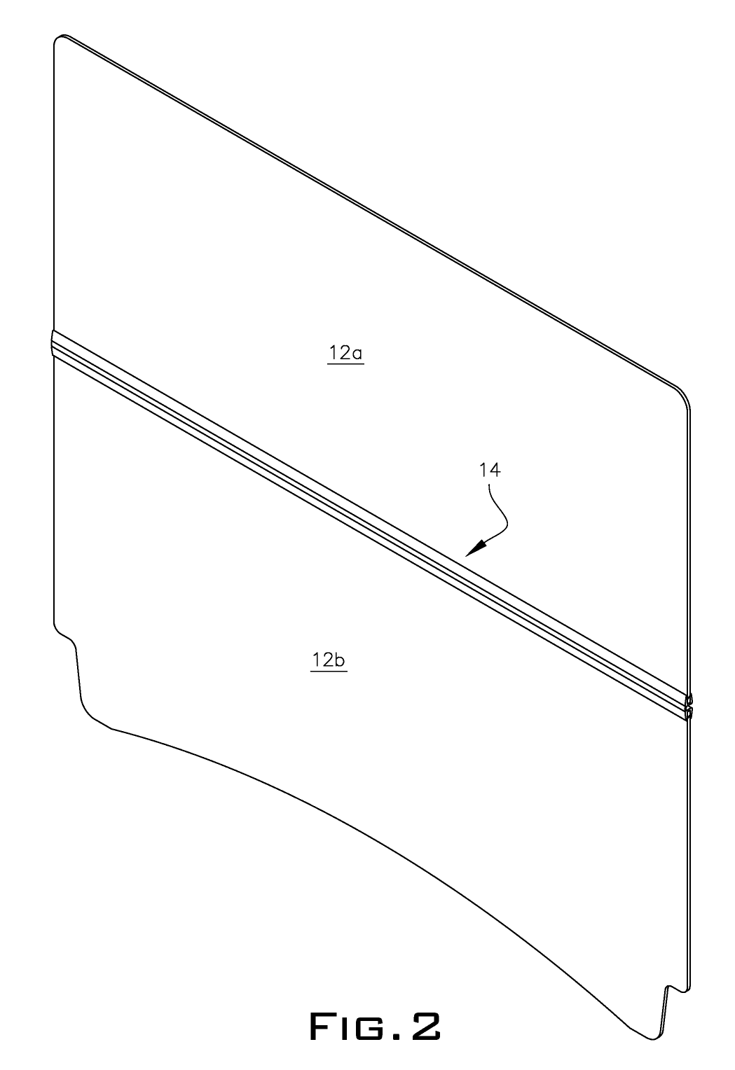

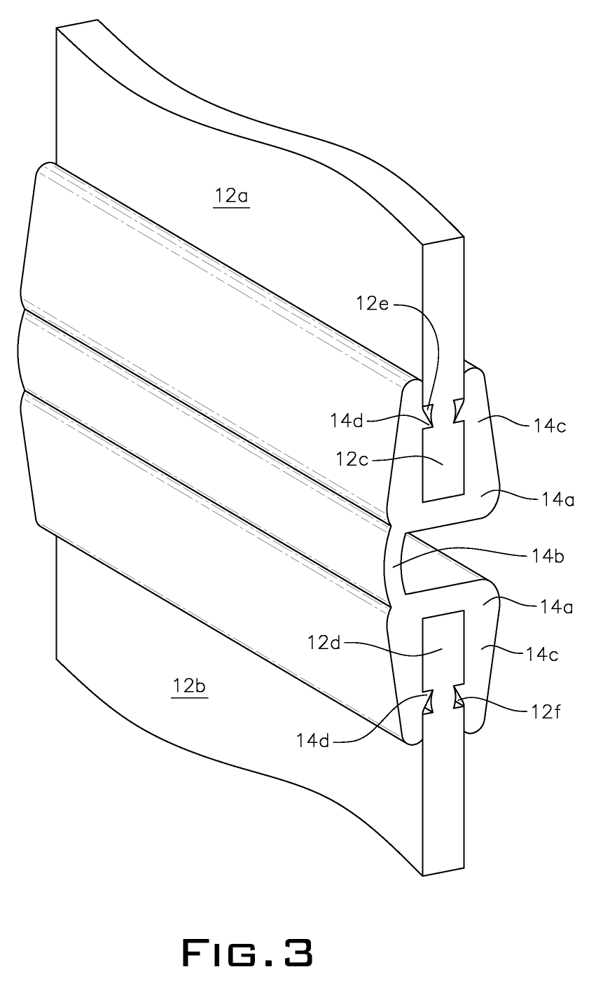

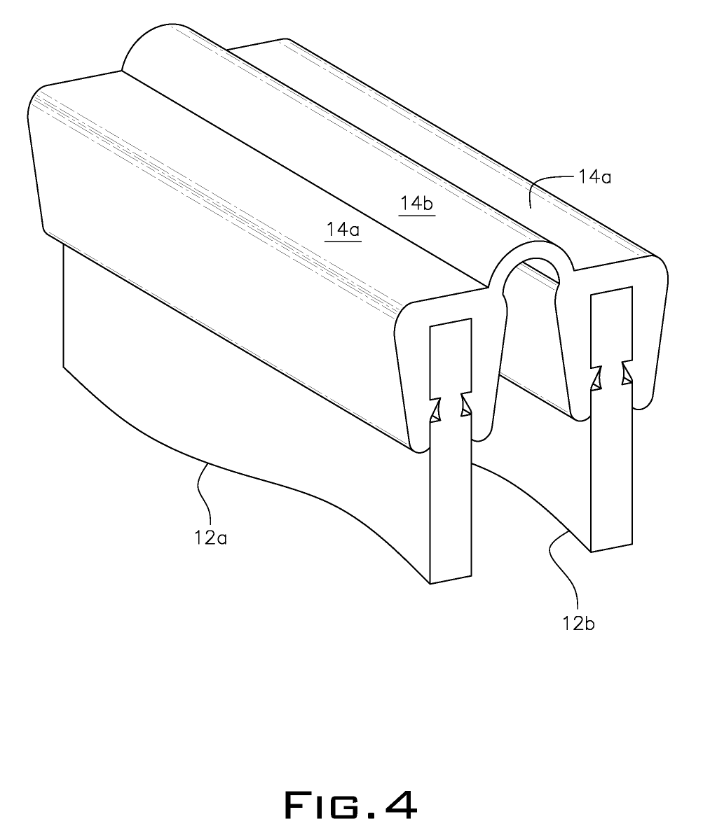

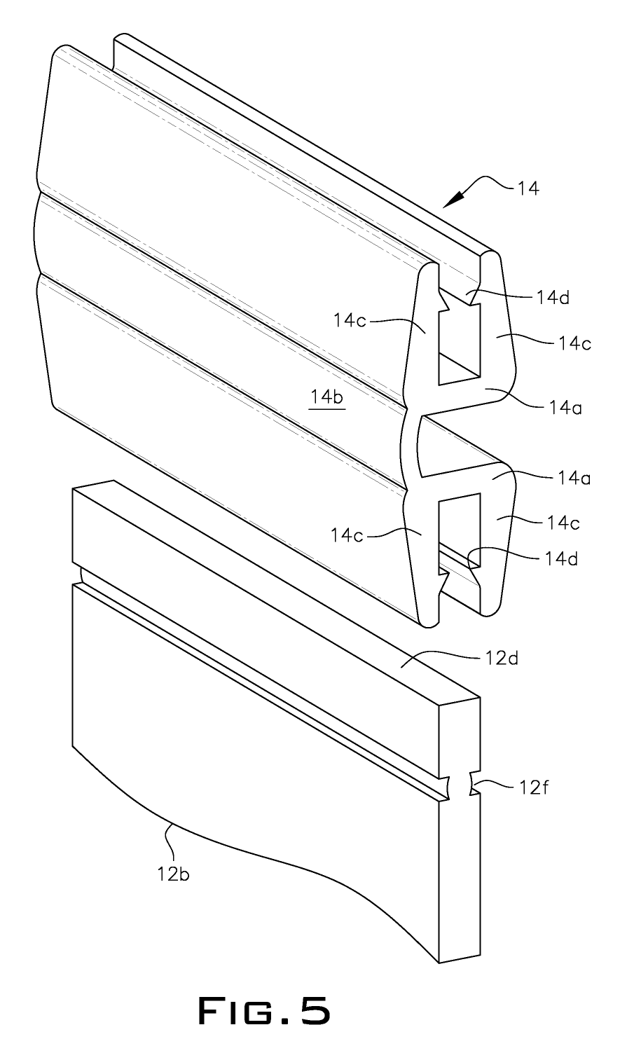

As depicted in FIGS. 2-5, the hinge mechanism 14 comprises two opposing spaced-apart C-shaped members 14a joined together by a flexible and foldable intermediate member 14b. The intermediate member 14b serves to hingedly rotate the upper and lower portions 12a,12b of the windshield 12 when desired. Typically the lower portion 12b is coupled or otherwise attached to the frame 22 of the golf cart 20 and the upper portion 12a can be hinged upwardly to couple to the upper part of the frame of the golf cart or the upper portion 12a can be hinged downwardly when desired to fold and rest against or parallel to the lower portion 12b.

The C-shaped members 14a include means for interlockingly engaging sides 12c,12d of respective upper and lower portions 12a,12b of the windshield 12 within respective legs 14c of each C-shaped member 14a.

Each C-shaped member 14a further comprises a ridge 14d extending inwardly from each of said respective legs 14c. The ridge 14d is configured to frictionally engage and interlock with a mating groove 12e, 12f in each of the upper and lower portions 12a, 12b of the windshield 12. The ridge 14d is tapered so as to facilitate the sliding engagement of the sides of the respective upper and lower portions 12a,12b of the windshield 12 within the respective legs 14c of each C-shaped member 12a.

Each C-shaped member 14a is made from a polyvinyl chloride (PVC) based material and the flexible and foldable intermediate member 14b is made from a resilient and durable polyurethane based material. The C-shaped members 14a are each integrally bonded to respective ends of the flexible and foldable intermediate member 14b using an extrusion manufacturing process. Such a process is known in the art. In the instant case, the PVC is fed through one extrusion and the polyurethane is fed through another extrusion process. The extrusion process paths meet together to integrally form the hinge mechanism 14 as a bond is formed between the two materials creating the hinge 14. As the newly formed hinge travels through the extruder, it reaches a chiller, which lowers the temperature of the hinge so it can maintain the shape. The hinge is then cut to the desired lengths. The polyvinyl chloride based material preferably has a durometer of about 90 or greater.

The groove 12e,12f in each of the upper and lower portions 12a,12b of the windshield 12 preferably has a width of about 2 mm on each opposite surface of the windshield 12, a depth of about 0.9 mm and is spaced about 6.5 mm from an edge of the windshield 12. Each of the ridges 14d in the legs 14c of the C-shaped member 14a are spaced-apart from each other so as to form a gap therebetween of about 2.2 mm. The flexible and foldable intermediate member 14b preferably has a thickness of about 1.5 mm and a length of about 5.4 mm.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

1. Windshield hinge system for use with a golf cart folding windshield comprising:
a golf cart windshield, said windshield being made from a plastic base material and comprising an upper portion and a lower portion;
said upper and lower portions being hingedly joined together at an intermediate level with a hinge mechanism;
said hinge mechanism comprising two opposing spaced-apart C-shaped members joined together by a flexible and foldable intermediate member, said flexible and foldable intermediate member serving to hingedly rotate said upper and lower portions of the windshield when desired;
said C-shaped members having means for interlockingly engaging sides of respective upper and lower portions of the windshield within respective legs of each C-shaped member
wherein the means for interlockingly engaging sides of respective upper and lower portions of the windshield within respective legs of each of said C-shaped members comprises a ridge extending inwardly from each of said respective legs, said ridge being configured to frictionally engage and interlock with a mating groove in each of said upper and lower portions of said windshield, and
said groove in each of said upper and lower portions of said windshield is configured to engage with said means in said C-shaped members for interlockingly engaging sides of respective upper and lower portions of the windshield,
wherein said upper and lower portions of said windshield are snapped into respective mating C-shaped members for completing said interlocking engagement.

2. (canceled)

3. The windshield hinge system according to claim 1, wherein said ridge is tapered so as to facilitate the sliding engagement of said sides of said respective upper and lower portions of the windshield within said respective legs of each C-shaped member.

4. The windshield hinge system according to claim 1, wherein each of said C-shaped members is made from a polyvinyl chloride based material and said flexible and foldable intermediate member is made from a resilient and durable polyurethane based material, wherein said C-shaped members are each integrally bonded to respective ends of said flexible and foldable intermediate member.

5. The windshield hinge system according to claim 4, wherein said polyvinyl chloride based material has a durometer of about 90 or greater.

6. The windshield hinge system according to claim 1, wherein said groove in each of said upper and lower portions of said windshield has a width of about 2 mm on each opposite surface of said windshield, a depth of about 0.9 mm and is spaced about 6.5 mm from an edge of said windshield.

7. The windshield hinge system according to claim 1, wherein each of said ridges in said C-shaped member is spaced-apart from each other so as to form a gap therebetween of about 2.2 mm.

8. The windshield hinge system according to claim 1, wherein said flexible and foldable intermediate member has a thickness of about 1.5 mm and a length of about 5.4 mm.
